(19) United States
(12) Patent Application Publication
(10) Pub. No.: US 2007/0198911 A1
(43) Pub. Date: Aug. 23, 2007

(54) Tabular environment that supports column rules and cell rules

(75) Inventors: Nikhil Nilakantan, Dallas, TX (US); Gerald Squelart, Malvern East (AU); Jean-Yves Avenard, Surrey Hills (AU)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/360,258

(22) Filed: Feb. 23, 2006

(51) Int. Cl. G06F 17/00; G06F 3/048

(52) U.S. Cl. 715/509; 715/510; 715/503; 715/777

(57) ABSTRACT

A computing device 100 is provided that includes a graphic user interface (GUI) 104 and a processor 102 coupled to the GUI 104. The computing device 100 also includes a memory 106 coupled to the processor 102. The memory 106 stores a tabular application for execution by the processor 102, the tabular application providing, on the GUI 104, a tabular environment that supports both column rules and cell rules.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to a computing environment capable of displaying mathematical information, and more particularly, but not by way of limitation, to a tabular computing environment that displays mathematical information.

### BACKGROUND OF THE INVENTION

Many computing devices (e.g., computers and calculators) support mathematical operations and the presentation of related information (e.g., text, graphs). The capabilities of these computing devices vary based on features such as processing capability, memory capacity, and supported applications. Some computing devices support a tabular (i.e., a plurality of cells organized in rows and columns) environment. Tabular environments can be used to perform mathematical operations, to display data, or both. Increasing the utility or user-friendliness of such environments would be desirable.

### SUMMARY OF THE INVENTION

In at least some embodiments, a computing device is provided that includes a graphic user interface (GUI) and a processor coupled to the GUI. The computing device also includes a memory coupled to the processor. The memory stores a tabular application for execution by the processor, the tabular application providing, on the GUI, a tabular environment that supports both column rules and cell rules.

In at least some embodiments a storage medium is provided. The storage medium stores computer-readable instructions that, when executed, cause a computing device to display a tabular environment. The storage medium stores computer-readable instructions that, when executed, further cause a computing device to associate a column formula input to a predetermined cell of the tabular environment with an entire column of the tabular environment.

In at least some embodiments, a method comprises applying a column rule to an entire column of a tabular environment. The method further comprises applying a cell rule to a cell of the tabular environment and updating values in the tabular environment based on the column rule and the cell rule.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a computing device in accordance with embodiments of the disclosure;

FIG. 2 illustrates a tabular environment in accordance with embodiments of the disclosure; and

FIG. 3 illustrates a method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the invention provide a tabular environment. In at least some embodiments, the tabular environment enables a user to apply rules to an entire column of data and to individual cells of data. For example, a user may input a column rule manually by inputting the rule (e.g., a formula) into a predetermined cell. The column rule would then apply to the entire column associated with the predetermined cell. Additionally or alternatively, the tabular environment may provide preprogrammed column rules based on a user selecting a type of problem or mathematical operation to perform. In some embodiments, the tabular environment enables a user to save a set of column rules and/or cell rules for future use.

Embodiments of the inventions are related to U.S. patent application Ser. No. ______, entitled Sixteen Direction Switch for a Cursor Device, Russell Stilley et al. inventors, Attorney Docket No. (TI-62053P)(1962-30900), U.S. patent application Ser. No. ______, entitled Modeling Environment with Generally Accessible Variables for Dynamically Linked Mathematical Representation, Nikhil Nilakantan et al. inventors, Attorney Docket No. (TI-62056P)(1962-31000), U.S. patent application Ser. No. ______, entitled Dynamic Data Flow and Data Linking, Gregory Springer et al. inventors, Attorney Docket No. (TI-61634P)(1962-30700), and U.S. patent application Ser. No. ______, entitled Using a Document Model to Create and Maintain Dynamic Mathematic Representations Through Problem Spaces, Nikhil Nilakantan et al. inventors, Attorney Docket No. (TI-62057P)(1962-31100), all of which are filed on even date herewith and all of which are incorporated herein by reference for all purposes.

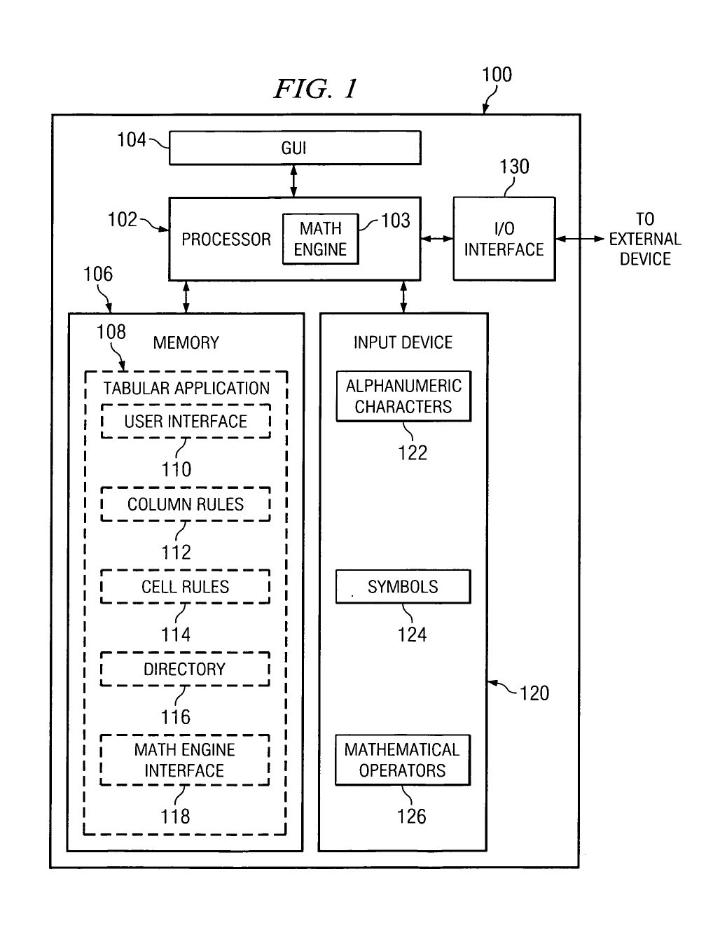

FIG. 1 illustrates a computing device 100 in accordance with embodiments of the disclosure. In some embodiments, the computing device 100 is a desktop computer or laptop computer. Alternatively, the computing device 100 could be a handheld calculator. As shown in FIG. 1, the computing device 100 comprises a processor 102 having a math engine 103. The math engine 103 comprises logic configured to handle certain mathematical operations quickly and efficiently. Some mathematical operations supported by the math engine 103 include, but are not limited to, a “mean” operation (for averaging a plurality of values), a “solve” operation (for solving an equation), a “min” operation (for determining a minimum zero slope value), a “max” operation (for determining a maximum zero slope value), a “sum” operation (for determining a sum of a plurality of values), a “product” (for determining a product of a plurality of values). In addition to or instead of implementing the math engine 103, some embodiments could implement a software-based math engine for execution by the processor 102. In either case, a tabular application 108 provided by the computing device 100 is compatible with mathematical operations supported by the computing device 100.

As shown in FIG. 1, the processor 102 couples to a graphic user interface (GUI) 104. The GUI 104, for example, could be a monitor, a liquid crystal display (LCD), or other GUI capable of displaying text, mathematical symbols, mathematical operators, and/or graphs. The processor 102 also couples to an input device 120 which enables a user to input alphanumeric characters 122, mathematical symbols (e.g., “Φ”, “Ω”, “Δ”, “Σ”, “μ”) 124 and mathematical operators (e.g., “+”, “−”, “*”, “/”, “abs( )”, “mean( )”) 126 for use with the tabular application 108. If the computing device 100 is a calculator, the input device 120 may comprise a plurality of input buttons associated with alphanumeric characters 122, mathematical symbols 124 and mathematical operators 126. In at least some embodiments, the input buttons are located on the face of the calculator for selection by a user. If the computing device 100 is a computer, the input device 120 may comprise a keyboard and mouse. If an alphanumeric character 122, mathematical symbol 124 or mathematical operator 126 is not available on the keyboard (or the input buttons of the calculator), the user may select available alphanumeric characters 122, mathematical symbols 124 or mathematical operators 126 displayed on the GUI 104 as part of the tabular application 108 or other related applications.

In FIG. 1, the computing device 100 comprises an input/output (I/O) interface 130 coupled to the processor 102. The I/O interface 130 enables the computing device 100 to download data compatible with the tabular application 108. For example, via the I/O interface 130, the computing device 100 could download applications, documents, graphs, word problems, data sets, formulas, columns rules, cell rules or other data for use with the tabular application 108. In some embodiments, a file or document downloaded for use with the tabular environment can support one or more instances (pages) of the tabular environment as well as one or more instances of a word problem environment and one or more instances of a graphing environment.

Additionally or alternatively, the I/O interface 130 enables the computer device 100 to upload data from the tabular application 108 to an external device. For example, via the I/O interface 130, the computing device 100 could upload data that enables the applications being executed by the computing device 100 to be displayed by a projector or other external device. In this manner, the tabular application 108 and related applications (e.g., words problem applications or graphing applications) can be viewed by a larger audience (e.g., in a classroom environment). Additionally or alternatively, the computing device 100 could upload files (documents) to other computing devices. Each computing device could execute (or share) a version of the tabular application 108, open the uploaded document, and view or modify data in one or more tabular environments provided with the document. If the document also includes graphing environments and/or word problem environments, these environments can be viewed or modified as well.

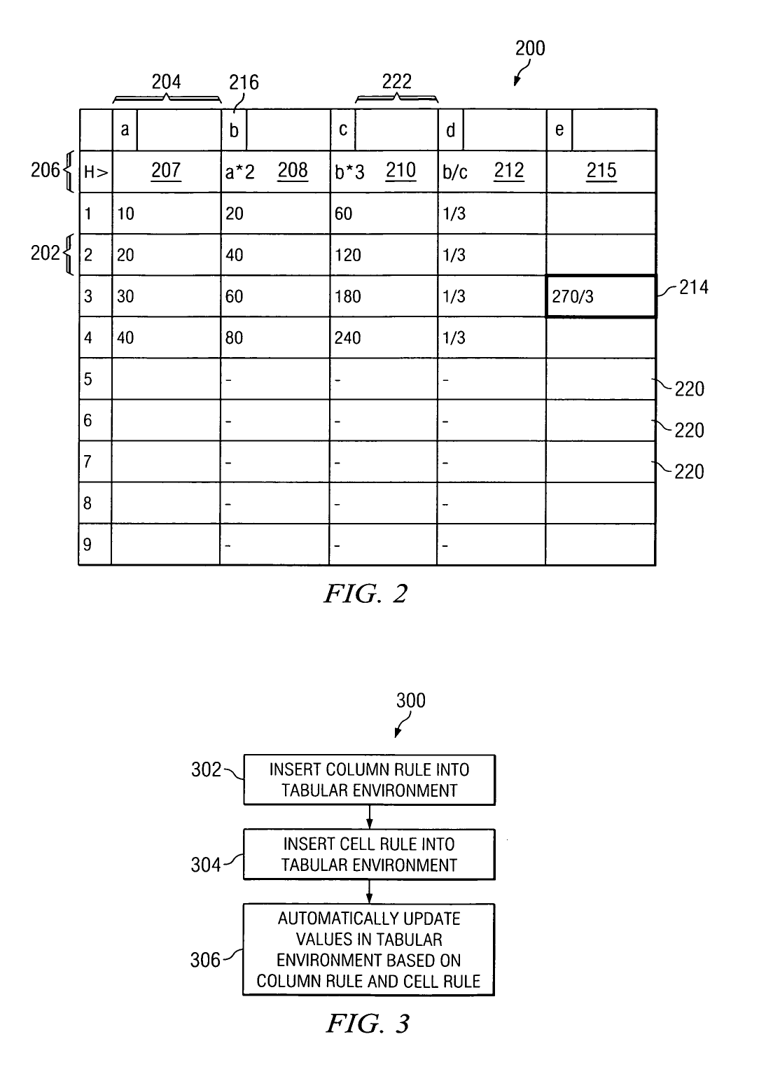

In FIG. 1, the processor 102 couples to a memory 106 that stores the tabular application 108. As shown, the tabular application 108 comprises user interface instructions 110, column rules instructions 112, cell rules instructions 114, directory instructions 116 and math engine interface instructions 118. When executed (e.g., by the processor 102), the user interface instructions 110 causes the processor 102 to display a tabular environment on the GUI 104. For example, the tabular environment may have a plurality of cells organized into columns and rows. A description of a tabular environment is provided later in FIG. 2. The user interface instructions 110 enable the user to input data, to view data, and/or to modify data in the tabular environment. In some embodiments, the data in the tabular environment can be provided to or from a graphing environment. For example, data points on a graph or information related to a graph (slope, maximums, minimums) can be provided to or from the tabular environment. Additionally or alternatively, the data in the tabular environment can be provided to or from a word problem environment. For example, variables (i.e., predetermined terms or symbols) and values for variables used in the word problem can be provided to or from the tabular environment. The graphing environment and word problem environment can be stored in the memory 106 and executed by the processor 102 in conjunction with the tabular environment.

When executed, the column rules instructions 112 cause the processor 102 to associate a rule or formula with an entire column of the tabular environment. Alternatively, the rule could be associated with an entire row of the tabular environment. In some embodiments, a user may input/modify a column rule manually by inputting the rule (e.g., a formula) into a predetermined cell (e.g., a header cell) associated with a column. Additionally or alternatively, the tabular environment may provide predetermined column rules. For example, a user may open a document which already has column rules in the tabular environment. In at least some embodiments, documents for the tabular environment may be selected from a directory of documents. Once a column rule has been successfully entered or modified, the column rule causes the processor 102 to automatically update the data in the cells of the related column and/or to update the data in the column “as needed” (e.g., based on changes that occur in the tabular environment).

When executed, the cell rules instructions 114 cause the processor 102 to associate a rule or formula with an individual cell of the tabular environment. In some embodiments, a user may input a cell rule manually by inputting the rule (e.g., a formula) into the cell which is to apply the rule. Additionally or alternatively, the tabular environment may provide predetermined cell rules. For example, a user may open a document which already has cell rules in the tabular environment. In at least some embodiments, documents for the tabular environment may be selected from a directory of documents. Once a cell rule has been successfully entered or modified, the cell rule causes the processor 102 to automatically update the data in the related cell and/or to update the data in the cell “as needed” (e.g., based on changes that occur in the tabular environment).

When executed, the directory instructions 116 cause the processor 102 to store documents in or to retrieve documents from a directory (e.g., a database) of documents. In some embodiments, the directory is organized and updated based on input from a user. For example, if a user has prepared a tabular environment with certain column rules and/or cell rules to execute a particular problem or mathematical operation, the user may want to store the tabular environment for future use. In such case, the user could store a tabular environment with its set of column rules and/or cell rules in the directory by designating a document name, directory location, or other information to later identify the tabular environment. The directory can be organized in any suitable manner (e.g., using appropriate names or titles to organize the directory contents). For example, the directory could organize documents for use particular problem types or mathematical operations. If available, the user could also download new documents for use with the tabular application 108 via the I/O interface 130 coupled to the processor 102. These new documents could be added to the directory for selection by the user.

When executed, the math engine interface 118 causes the processor 102 to execute mathematical operations supported by the math engine 103 and referenced in the tabular environment. In some embodiments, a mathematical operation can be referenced in the tabular environment using labels. For example, the character “*” may reference a multiplication operation, the term “abs( )” may reference an absolute value operation, the term “mean( )” may reference a mean operation and so on. The math engine 103 could be implemented by logic in the processor 102 or by software instructions stored in the processor 102 or in the memory 106. In either case, the math engine interface 118 provides input to and receives output from the math engine 103. The input to the math engine 103 can be provided, for example, from the data and labels in the tabular environment. Also, the output from the math engine 103 can be provided, for example, as data displayed in the tabular environment.

FIG. 2 illustrates a tabular environment 200 in accordance with embodiments of the disclosure. As shown in FIG. 2, the tabular environment 200 comprises a plurality of cells 220 organized into rows 202 and columns 204. In some embodiments, each column is referenced by a column label 216. For example, FIG. 2 shows columns referenced by the labels “a”, “b”, “c”, “d”, and “e” and rows referenced by the labels “1”, “2”, “3” and so on. Cell 1 of column “a” can be referenced by the label “a1”, cell 3 of column “d” can be referenced by the label “d3” and so on. These labels can be used to input column rules or formulas into predetermined cells (e.g., the header cells 206).

Near each label 216, additional space 222 is provided to further identify each column. The additional space 222 can contain any term, variable or symbol desired by a user. If data in the tabular environment is related to a word problem environment or graphing environment, the additional space 222 can display a term, a variable, or a symbol that is provided to or from the word problem environment or graphing environment. Also, the column rules and cell rules could be entered using the generic column labels (“a”, “b”, “c”, “d” and “e”) or any term, variable, or symbol in the additional space 222 that does not conflict with the generic column symbols. As an example, a user could enter the term “length” in the additional space 222 of column “a”, the term “width” in the additional space 222 of column “b”, and the term “area” in the additional space 222 of column “c”. In the header cell of column “c”, a user could enter the formula “length*width” whereby each cell value of column “c” (labeled “area”) is equal to a cell value from the column “a” (labeled “length”) times a cell value from column “b” (labeled “width”). For example, the value in cell 1 of column “c” (area) would equal the value in cell 1 of column “a” (length) times the value in cell 1 of column “b” (width). Alternatively, the user could simply enter the formula “a*b” in the header cell of the column “c”, which would have the same effect as using labels in the “length*width” formula described above. Accordingly, generic column labels, user-selected labels (“length”, “width”, “area”) or both can be used to identify columns and column rules.

In FIG. 2, column rules can be inserted and displayed in a header cell 206 for each column. A column rule would apply to the cells under each header cell 206. For example, column “a” is shown as having no rule in its header cell 207. Column “b” is shown as having the rule “a*2” in its header cell 208. Thus for column “b”, each cell value of column “a” is multiplied by two and displayed in a corresponding cell of column “b” (e.g., the value of cell a1 is multiplied by 2 and displayed in cell b1). Column “c” is shown as having the rule “b*3” in its header cell 210. Thus for column “c”, each cell value of column b is multiplied by 3 and displayed in a corresponding cell of column “c” (e.g., the value of cell b2 is multiplied by 3 and displayed in cell c2). Column “d” is shown as having the rule “b/c” in its header cell 212. Thus for column “d”, each cell value of column “b” is divided by a corresponding cell value of column “c”. The final result of the division is displayed in a corresponding cell of column “d” (e.g., the value of cell b2 is divided by the value of cell c2 and the final result is played in cell d2). Column “e” is shown as having no rule in its header cell 215. By displaying a column rule in a column header 206, a user can easily identify the column rule and, if desired, modify the rule. The column rules can implement one or more math operators (“+”, “−”, “*”, “/” “abs( )”, “mean( )”) supported by the math engine 103 as well as one or more generic column labels (“a”, “b”, “c”), user-selected column labels (“length”, “width”, “area”), generic cell labels (“a1”, “b1”, “c2”), generic row labels (“r1”, “r2”, “r3”), numeric values (1, 2, 3), or other input.

In addition to supporting column rules, the tabular environment 200 also supports cell rules. In FIG. 2, cell e3 implements a cell rule. The cell rule for cell e3 is (a3+b3+c3)*d3 and the final value based on the cell rule is shown as 270/3 (30+60+180)*(⅓). In at least some embodiments, the cell rules are not shown in the tabular environment 200 unless a user selects to view or modify the cell rule. For example, if the user selects the cell e3, a window showing the cell rule for cell e3 could appear (e.g., on the GUI 104), enabling the user to view and/or modify the cell rule. Cell rules can implement any desired combination of generic cell labels, user-selected labels, numeric values, mathematical operators or other input.

By supporting column rules and cell rules in the same tabular environment 200, a user can choose to apply column rules, cell rules, or both. As data is added to the tabular environment 200, the column rules and cell rules automatically update affected cell values. For example, if a value of 50 is added in cell a5, cell b5 would automatically display a value of 100 (based on the column rule “a*2”), cell c5 would automatically display a value of 300 (based on the column rule “b*3”), and cell d5 would automatically display a value of ⅓.

FIG. 3 illustrates a method 300 in accordance with embodiments of the disclosure. As shown in FIG. 3, the method 300 comprises inserting a column rule into a tabular environment (block 302). As previously described, the column rule can be inserted manually by selecting a predetermined cell (e.g., a column header) associated with a column and inserting a rule or formula into the predetermined cell. Alternatively, a column rule can be selected from a directory of column rules. If desired, a user can add column rules to the directory or delete column rules from the directory. Also, if available, the user can download column rules to the directory for application in the tabular environment. In some embodiments, a column rule is continuously displayed in a header cell of the associated column. In alternative embodiments, the column rule is hid unless a user selects the predetermined cell associated with the column rule.

At block 304, the method 300 inserts a cell rule into the tabular environment. The cell rule can be inserted manually by selecting the cell that applies the cell rule and inserting a rule or formula into the cell. Alternatively, a cell rule can be selected from a directory of cell rules. If desired, a user can add cell rules to the directory or delete cell rules from the directory. Also, if available, the user can download cell rules to the directory for application in the tabular environment. In some embodiments, the cell rule is hid unless a user selects the cell associated with the cell rule.

Finally, in method 300, values in the tabular environment are automatically updated based on the column rule and the cell rule (block 306). Thereafter, if a user adds/changes data in the tabular environment, the column rule and cell rule automatically update any cells affected by the additions/changes.

While several embodiments have been provided in the present disclosure, it should be understood that the disclosed systems and methods may be embodied in many other specific forms without departing from the spirit or scope of the present disclosure. For example, instead of displaying a tabular environment in which cells are divided by lines (as shown in FIG. 2), some tabular environments may display tables in which no cells are divided by lines or some cells are divided by lines, but not other cells. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A computing device, comprising:
a graphic user interface (GUI)
a processor coupled to the GUI; and
a memory coupled to the processor,
wherein the memory stores a tabular application for execution by the processor, the tabular application providing, on the GUI, a tabular environment that supports both column rules and cell rules.

2. The computing device of claim 1 further comprising an input/output (I/O) interface coupled to the processor, wherein documents having predetermined column rules are downloaded to the memory via the I/O interface.

3. The computing device of claim 1 wherein the computing device comprises a calculator.

4. The computing device of claim 3 wherein the processor comprises a math engine.

5. The computing device of claim 4 wherein the tabular application comprises a math engine interface that relates predetermined labels used in the tabular environment with mathematical functions supported by the math engine.

6. The computing device of claim 1 further comprising an input device coupled to the processor, wherein the input device enables a user to enter alphanumeric characters, mathematical symbols and mathematical operators for use with the tabular environment.

7. The computing device of claim 6 wherein the input device comprises buttons on the face of a calculator.

8. The computing device of claim 1 wherein the tabular environment receives data from and provides data to a word problem environment.

9. The computing device of claim 7 wherein the tabular environment receives data from and provides data to a graphing environment.

10. The computing device of claim 1 wherein a column rule is manually entered by selecting a predetermined cell associated with an entire column.

11. The computing device of claim 10 wherein the predetermined cell comprises a header cell associated with a column.

12. The computing device of claim 1 wherein the column rule of a given column applies a mathematical function to each cell of another column and places a result in each corresponding cell of the given column.

13. A storage medium that stores computer-readable instructions that, when executed, cause a computing device to:
display a tabular environment; and
associate a column formula input to a predetermined cell of the tabular environment with an entire column of the tabular environment.

14. The storage medium of claim 13 wherein, when executed, the computer-readable instructions cause the computing device to associate a cell formula input to a cell of the tabular environment with the cell.

15. The storage medium of claim 14 wherein, when executed, the computer-readable instructions cause the computing device to establish a directory of documents, at least one of the documents storing column formulas of a tabular environment.

16. The storage medium of claim 13 wherein, when executed, the computer-readable instructions cause the computing device to automatically update data in the tabular environment based on the column formula.

17. The storage medium of claim 13 wherein, when executed, the computer-readable instructions cause the computing device to interface labels used in the tabular environment with mathematical functions supported by a math engine.

18. A method, comprising:
applying a column rule to an entire column of a tabular environment;
applying a cell rule to a cell of the tabular environment; and
updating values in the tabular environment based on the column rule and the cell rule.

19. The method of claim 18 further comprising providing interfacing data in the tabular environment with another environment selected from the group consisting of a graphing environment and a word problem environment.

20. The method of claim 18 further comprising manually inserting the column rule into a header cell of the column.
